(19) United States
(12) Patent Application Publication
(10) Pub. No.: US 2025/0150302 A1
(43) Pub. Date: May 8, 2025

(54) PRELOADING A CUSTOMER CONTEXT IN A VIRTUAL GATEWAY

(71) Applicant: Charter Communications Operating, LLC, St. Louis, MO (US)

(72) Inventors: Timothy Clark Bleidorn, Colorado Springs, CO (US); Christopher David Coulson, Highlands Ranch, CO (US)

(21) Appl. No.: 18/500,647

(22) Filed: Nov. 2, 2023

(51) Int. Cl. H04L 12/46; H04L 69/324

(52) U.S. Cl. CPC H04L 12/4641; H04L 69/324

(57) ABSTRACT

A bridged gateway coupled to a local area network (LAN) in a premises establishes a layer 2 tunnel with a first computing device coupled to a different network, the first computing device operable to provide a virtual gateway that provides default gateway functionality to computing devices connected to the LAN. The bridged gateway generates a first message to be processed by the virtual gateway. The bridged gateway sends the first message to the computing device to cause the first computing device to initiate the virtual gateway.

### BACKGROUND

It can be desirable for a service provider to move functionality conventionally provided by a router in a subscriber's home to the service provider's network for a variety of reasons, including, for example, to reduce a need to send a technician to a customer premises to diagnose and correct issues, facilitate faster problem resolution, and simplify introducing new features.

### SUMMARY

The examples disclosed herein preload a customer context in a virtual gateway prior to a LAN-connected computing device seeking a service from the virtual gateway.

In one implementation a method is provided. The method includes establishing, by a bridged gateway coupled to a local area network (LAN) in a premises, a layer 2 tunnel with a first computing device coupled to a different network, the first computing device operable to provide a virtual gateway that provides default gateway functionality to computing devices connected to the LAN. The method further includes generating, by the bridged gateway, a first message to be processed by the virtual gateway. The method further includes sending, by the bridged gateway to the computing device, the first message to cause the first computing device to initiate the virtual gateway.

In another implementation a computing device is provided. The computing device includes a memory, a transceiver operable to be coupled to a local area network (LAN), and a processor device coupled to the memory and the transceiver and being operable to establish a layer 2 tunnel with a remote computing device coupled to a different network, the remote computing device operable to provide a virtual gateway that provides default gateway functionality to computing devices connected to the LAN. The transceiver is further operable to generate a first message to be processed by the virtual gateway. The transceiver is further operable to send, to the remote computing device, the first message to cause the remote computing device to initiate the virtual gateway.

In another implementation a method is provided. The method includes establishing, by a computing device coupled to a network, a layer 2 tunnel with a bridged gateway coupled to a local area network (LAN) in a premises, the computing device being operable to provide a virtual gateway that provides default gateway functionality to computing devices connected to the LAN. The method further includes receiving, by the computing device from the bridged gateway via the layer 2 tunnel a message originating from the bridged gateway for processing by the virtual gateway. The method further includes determining, by the computing device, that the virtual gateway has not been initiated. The method further includes initiating, by the computing device, the virtual gateway. The method further includes providing, by the computing device to the virtual gateway, the message.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram suitable for preloading a customer context in a virtual gateway according to one implementation;

FIG. 2 is a flowchart of a method for preloading a customer context in a virtual gateway according to one implementation;

FIG. 3 is a flowchart of a method for keeping a virtual gateway instantiated according to one implementation;

FIG. 4 is a flowchart of a method for initiating a virtual gateway according to one implementation;

FIG. 5 is a sequence diagram illustrating messages communicated between and actions taken by certain components illustrated in FIG. 1 to implement preloading a customer context in a virtual gateway according to one implementation; and

FIG. 6 is a block diagram of a bridged gateway suitable for implementing examples disclosed herein.

### DETAILED DESCRIPTION

The examples set forth below represent the information to enable

individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Devices connected to a local area network (LAN) typically communicate with other devices connected to the same LAN via layer 2 communication protocols, and with devices connected to another LAN via layer 3 communication protocols. Layer 3 protocol communications are facilitated via a gateway router that is typically physically connected to the same LAN and also connected to another network, such as a network of a service provider that provides broadband access to the entity operating the LAN. The gateway router implements traditional gateway router services, such as dynamic host configuration protocol (DHCP) services for providing network-connected computing devices with internet protocol (IP) addresses as needed, network address translation (NAT) services to translate private IP addresses associated with a subnetwork to a public IP address, Domain Name System (DNS) services for translating a domain name to an IP address, and the like.

A service provider may desire to provide gateway router functionality from a location within the service provider's network rather than from the customer premises. Moving the gateway functionality from the subscriber's physical location to a network gateway router at a service provider's location, sometimes referred to as a “virtual gateway”, may make it easier to support customer issues and reduce the need to send a technician to a customer premises such as a home or business.

The terms subnetwork, or subnet, will be treated synonymously herein, and refer to a data communications network, often but not necessarily an Ethernet network, wherein each connected computing device on the subnet has an IP address that has the same network address, and which utilizes the same subnet mask to determine whether other computing devices are on the same network or are on a different network. Such computing devices may be referred to herein as being “on” or “connected to” or “coupled to” the same subnet. Computing devices on the same subnet can communicate with one another, typically via layer 2 addressing, such as a media access control (MAC) address, without the need for a router. A LAN is an example of a subnet.

Since a virtual gateway is not physically directly connected to the LAN in the same manner as a conventional gateway router, to implement a virtual gateway in a manner that is transparent to devices connected to the LAN, a device on the LAN, such as a bridged gateway, may establish a logical subscriber link (LSL) between the bridged gateway and the virtual gateway. The LSL is typically implemented as a layer 2 (over layer 3) tunnel between the bridged gateway and the virtual gateway, such as, by way of non-limiting example, a GRE tunnel. The bridged gateway may send layer 2 frames generated by devices on the LAN to the virtual gateway via the tunnel, and may receive layer 2 frames generated by the virtual gateway via the tunnel and send the layer 2 frames to a device or devices on the LAN. This is done transparently such that devices on the LAN are unaware that the virtual gateway is not actually directly connected to the same physical network as the devices on the LAN.

A virtual gateway is generated for each customer LAN and multiple virtual gateways may be implemented on a single computing device, sometimes referred to as a broadband network gateway (BNG). The virtual gateway may be a software process that is instantiated by the BNG upon the occurrence of some event, such as the receipt of traffic by the BNG from the bridged gateway. When the BNG initiates the virtual gateway, there may be a processing delay while the virtual gateway initializes. Moreover, the BNG must configure the virtual gateway with the appropriate subscriber context, such as the class of service, parental controls set up by the subscriber, the purchased bandwidth limits, preferential treatment for certain devices that may connect to the LAN, and the like.

The event that prompts the BNG to generate a virtual gateway for a subscriber LAN is often the initial receipt of traffic by the BNG from the bridged gateway. Initiating the virtual gateway and setting up the context can cause a delay of multiple seconds, and can cause dissatisfaction to the user who perceives this delay as non-responsiveness of the LAN. Similarly, to save resources, a BNG may deallocate the context from a virtual gateway, or even terminate a virtual gateway, after a period of time during which no traffic has been received from the bridged gateway. When a LAN-connected device subsequently sends traffic that is forwarded to the BNG, the BNG must again set up the virtual gateway with the appropriate context relating to that customer.

A bridged gateway does not typically unilaterally generate traffic to a BNG and thus, until a computing device attempts to obtain an IP address via DHCP, or otherwise generates traffic that will be processed by a virtual gateway, the BNG has no reason to initiate a virtual gateway for the LAN even though the bridged gateway may have been powered on long before the traffic associated with the computing device is received by the BNG.

The examples disclosed herein preload a customer context in a virtual gateway prior to a LAN-connected computing device seeking a service from the virtual gateway. A bridged gateway establishes a layer 2 tunnel with a BNG. The bridged gateway then unilaterally generates and sends a message via the layer 2 tunnel for processing by a virtual gateway. The BNG receives the message, determines that no virtual gateway exists, and instantiates a virtual gateway to process the message. The BNG configures the virtual gateway in accordance with the customer context. Subsequently, when a computing device connected or connecting to the LAN attempts to obtain a service from the virtual gateway, such as to obtain a DHCP address, the virtual gateway already exists and has the appropriate context. The virtual gateway can thus immediately respond to the request, eliminating what would otherwise be the period of time necessary to instantiate the virtual gateway and configure the virtual gateway with the appropriate customer context.

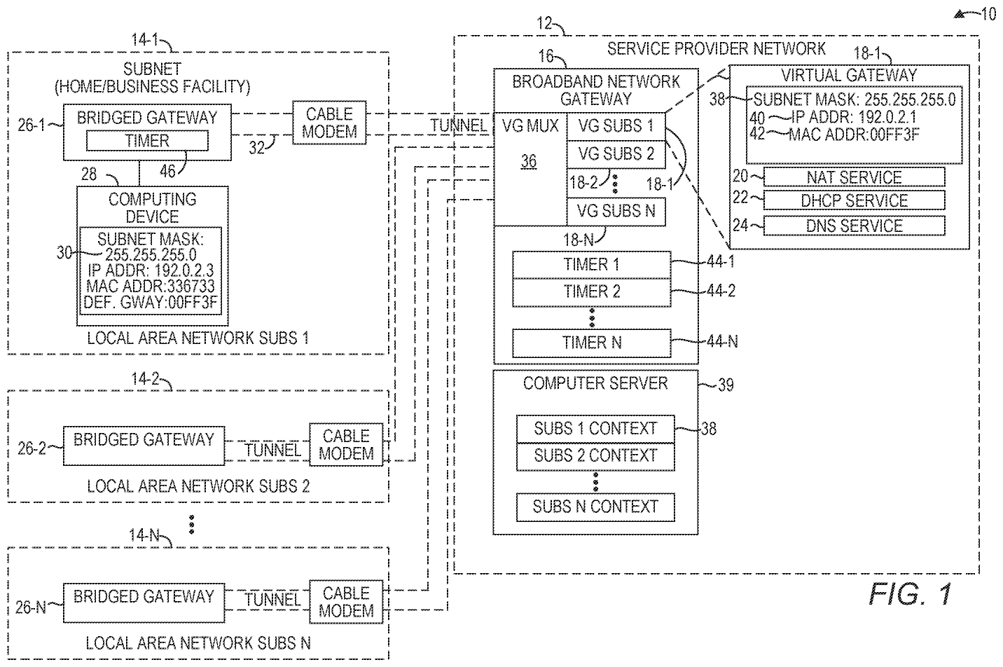

FIG. 1 is a block diagram of an environment 10 suitable for preloading a customer context in a virtual gateway according to one implementation. The environment 10 includes a service provider network 12 and a plurality of local area networks (LANs) 14-1-14-N (generally, LANs 14), located in subscribers' premises, such as businesses or homes. The service provider network 12 includes a broadband network gateway (BNG) 16 that is a remote (e.g., on another network) computing device that is configured to initiate a plurality of virtual gateways 18-1-18-N (generally, virtual gateways 18) that provide, for the LANs 14-1-14-N, default gateway router functions, such as, by way of non-limiting example, a NAT service 20, a DHCP service 22, a DNS service 24, and a router function to facilitate communication between a computing device connected to a corresponding LAN 14 and a computing device connected to another network. The BNG 16 is physically located in a facility controlled by the respective service provider, and may be located tens, hundreds, or thousands of miles from the LANs 14. In some embodiments, the virtual gateways 18 may comprise a virtual gateway as described in TR-317 Network Enhanced Residential Gateway, available at www.broadband-forum.org/download/TR-317.pdf.

The LANs 14-1-14-N each have bridged gateways 26-1-26-N, respectively. The bridged gateway 26-1 is coupled to the LAN 14-1 via a layer 2 transceiver, such as an Ethernet wired transceiver, a Wi-Fi transceiver, or both. The bridged gateway 26-1 is a learning bridge and may serve as a Wi-Fi access point and an Ethernet switch. The bridged gateway 26-1 also implements a transparent tunneling mechanism with the BNG 16 as will be described in greater detail below.

The bridged gateway 26-1 is communicatively coupled to one or more computing devices 28 via one or more networking technologies, such as Ethernet, Wi-Fi®, or the like. The bridged gateway 26-1 and the computing device 28 are all on the same subnet, and thus each use a same subnet mask 30 to determine whether another computing device is on the LAN 14-1 or on a different network.

During an initialization stage of the bridged gateway 26-1, the bridged gateway 26-1 establishes a layer 2 (via layer 3) tunnel 32 with the BNG 16. The tunneling protocol may comprise any suitable tunneling protocol; however, in some embodiments, the tunneling protocol comprises a layer 2 tunneling protocol such as, by way of non-limiting example, the generic routing encapsulation (GRE) tunneling protocol. The bridged gateway 26-1 and the BNG 16 use their respective IP addresses to establish the layer 2 (over layer 3) tunnel. There may be any number of devices between the bridged gateway 26-1 and the BNG 16, such as, by way of non-limiting example, a cable modem 34 and one or more switching devices (not illustrated) in the service provider network 12.

The BNG 16 does not initiate the virtual gateway 18-1 until a message, such as, by way of non-limiting example, a DHCP discover message or the like from the computing device 28, is received via the tunnel 32. Upon receipt of an initial message from the LAN 14-1 by the BNG 16, the BNG 16 determines that the virtual gateway 18-1 needs to be instantiated to process the message. The BNG 16 accesses a subscriber context 38 maintained by a computer server 39. The subscriber context 38 corresponds to the LAN 14-1 and contains information, such as the class of service, parental controls set up by the subscriber, the purchased bandwidth limits, preferential treatment for certain devices that may connect to the LAN, and the like, that are associated with the LAN 14-1. The BNG 16 then instantiates the virtual gateway 18-1 and configures the virtual gateway 18-1 using the subscriber context 38. The initiation and context configuration of the virtual gateway 18-1 takes time, which causes a delay at the computing device 28 that is awaiting a response to the DHCP request.

A virtual gateway multiplexer 36 then determines that the message is destined for the virtual gateway 18-1 and provides the message to the virtual gateway 18-1 for processing. The virtual gateway 18-1 is provided a same subnet mask 30 as the subnet mask 30 provided to the computing devices 28 on the LAN 14-1, and may be given an IP address 40 that is on the LAN 14-1. The virtual gateway 18-1 responds to the message using a layer 2 frame addressed to the computing device 28 and sends the layer 2 frame toward the bridged gateway 26-1. In the case where the message from the computing device 28 is a DHCP Discover message, the layer 2 frame may include an IP address for the computing device 28, the subnet mask 30, and an indication that the virtual gateway 18-1 is the default gateway router for the LAN 14-1. The virtual gateway 18-1 inserts a MAC address 42 as the MAC address of the virtual gateway 18-1 in the layer 2 frame.

The BNG 16 encapsulates the layer 2 frame into a layer 3 protocol, such as TCP/IP, and sends the layer 2 frame to the bridged gateway 26-1 via the tunnel 32. The bridged gateway 26-1 extracts the layer 2 frame from the layer 3 protocol and sends the layer 2 frame to the computing device 28 using the MAC address 42 of the virtual gateway 18-1 as the originator of the layer 2 frame. The computing device 28 receives the response to the DHCP request and perceives the virtual gateway 18-1 as being physically on the LAN 14-1 because the tunnelling of packets between the bridged gateway 26-1 and the BNG 16 is transparent to any computing device 28 connected to the LAN 14-1.

Subsequently, if the computing device 28 desires to send a packet to a computing device that is not on the LAN 14-1, the computing device 28 will address the packet to the virtual gateway 18-1 using the MAC address 42. The bridged gateway 26-1 will receive the packet, determine that the packet is addressed to the virtual gateway 18-1, encapsulate the packet in the layer 3 protocol and send the packet to the BNG 16 via the tunnel 32.

The virtual gateway multiplexer 36 will receive the packet, determine that the packet is destined for the virtual gateway 18-1, and send the packet to the virtual gateway 18-1. The virtual gateway 18-1 will then forward the packet to a router based on routing tables maintained by the virtual gateway 18-1 in the same manner as a conventional gateway router.

The bridged gateway 26-1 forwards all layer 2 frames generated by a computing device 28 on the LAN 14-1 that have a destination address of the virtual gateway 18-1 and all broadcast layer 2 frames to the virtual gateway 18-1. To the computing device 28, the virtual gateway 18-1 appears to be directly coupled to the LAN 14-1.

The bridged gateways 26-2-26-N operate substantially similarly to the bridged gateway 26-1.

To eliminate the delay experienced by the computing device 28 due to the need for the BNG 16 to initiate and configure the virtual gateway 18-1, in one implementation after the bridged gateway 26-1 establishes the tunnel 32 with the BNG 16, the bridged gateway 26-1 unilaterally sends a layer 2 message, such as, by way of non-limiting example, a gratuitous address resolution protocol (ARP) reply message, via the tunnel 32. This may occur, for example, during a power up or restart of the bridged gateway 26-1.

Upon receipt of the gratuitous ARP reply message, the BNG 16 determines that the virtual gateway 18-1 needs to be instantiated to process the message. The BNG 16 accesses the subscriber context 38 that corresponds to the LAN 14-1 and instantiates the virtual gateway 18-1, and configures the virtual gateway 18-1 using the subscriber context 38. The virtual gateway multiplexer 36 then determines that the message is destined for the virtual gateway 18-1 and provides the message to the virtual gateway 18-1 for processing.

When the computing device 28 subsequently connects to the LAN 14-1 and sends a message, such as a DHCP request to the virtual gateway 18-1 to obtain an IP address, the virtual gateway 18-1 has already been instantiated and configured with the subscriber context 38 and thus can respond to the computing device 28, eliminating the delay that would otherwise occur while the BNG 16 instantiated and configured the virtual gateway 18-1.

The BNG 16 may maintain a plurality of timers 44-1-44-N (generally, timers 44), each of which corresponds to a respective LAN 14-1-14-N. The BNG 16 may set each timer 44 to a predetermined value upon receipt of a message by a virtual gateway 18 from a computing device on a corresponding LAN 14. If the timer expires, the BNG 16 may then conclude that no device on the corresponding LAN 14 is active, and may terminate the virtual gateway 18 to make available memory and other resources that would otherwise be reserved for use by the virtual gateway 18. If a computing device subsequently becomes active on the LAN 14, the BNG 16 must then instantiate the virtual gateway 18, and configure the virtual gateway 18 using the corresponding subscriber context, again resulting in a network delay from the perspective of the computing device.

Accordingly, in some implementations, the bridged gateway 26-1 may periodically send a message, such as a gratuitous ARP message, to the virtual gateway 18-1, to ensure that the timer 42-1 does not expire and the virtual gateway 18-1 remains instantiated and ready to process messages from a computing device connected to the LAN 14-1.

In some implementations, the bridged gateway 26-1 may maintain a timer 46 and set the timer 46 to a predetermined amount of time. The bridged gateway 26-1 may reset the timer each time the bridged gateway 26-1 forwards a layer 2 frame received from a computing device 28 to the virtual gateway 18-1. If the timer expires, the bridged gateway 26-1 sends a message, such as a gratuitous ARP message, to the virtual gateway 18-1, and again sets the timer 46 to a predetermined amount of time to ensure that the virtual gateway 18-1 remains active on the BNG 16.

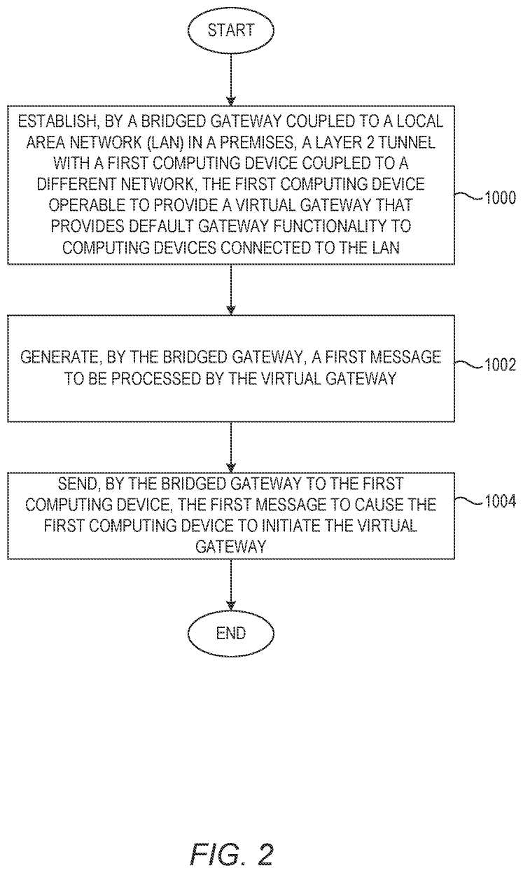

FIG. 2 is a flowchart of a method for preloading a customer context in a virtual gateway according to one implementation. FIG. 2 will be discussed in conjunction with FIG. 1. The bridged gateway 26-1, coupled to the LAN 14-1, establishes the layer 2 tunnel 32 with a computing device, such as the BNG 16 that is coupled to a different network, the BNG 16 being operable to provide the virtual gateway 18-1 that provides default gateway functionality to computing devices 28 connected to the LAN 14-1 (FIG. 2, block 1000). The bridged gateway 26-1 generates a message to be processed by the virtual gateway 18-1 (FIG. 2, block 1002). The bridged gateway 26-1 sends, to the BNG 16, the message to cause the BNG 16 to initiate the virtual gateway 18-1 (FIG. 2, block 1004).

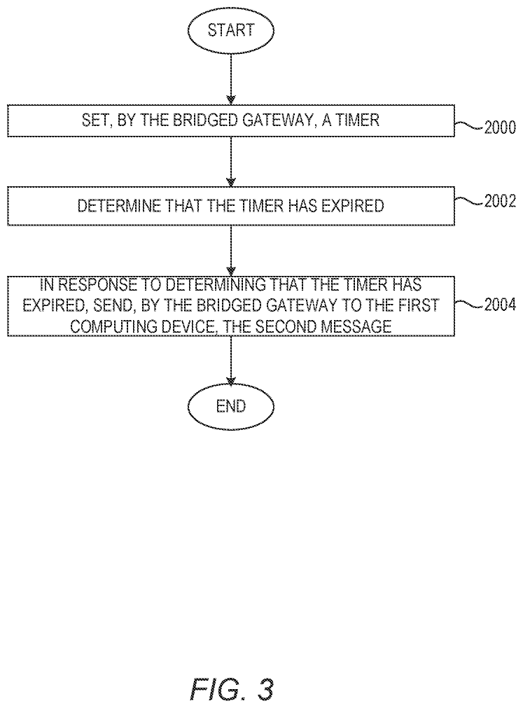

FIG. 3 is a flowchart of a method for keeping a virtual gateway instantiated according to one implementation. The bridged gateway 26-1 sets the timer 46 (FIG. 3, block 2000). The bridged gateway 26-1 determines that the timer 46 has expired (FIG. 3, block 2002). The bridged gateway 26-1, in response to determining that the timer 46 has expired, sends, to the BNG 16, a second message (FIG. 3, block 2004).

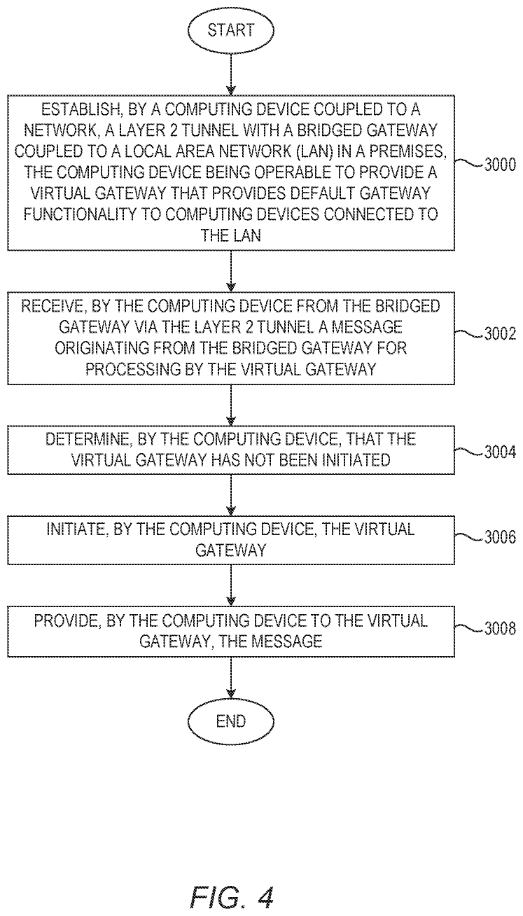

FIG. 4 is a flowchart of a method for initiating a virtual gateway according to one implementation. FIG. 4 will be discussed in conjunction with FIG. 1. The BNG 16 establishes the layer 2 tunnel 32 with the bridged gateway 26-1 coupled to the LAN 14-1 in a premises. The BNG 16 is operable to provide the virtual gateway 18-1 that provides default gateway functionality to computing devices connected to the LAN 14-1 (FIG. 4, block 3000). The BNG 16 receives, from the bridged gateway 26-1 via the layer 2 tunnel 32 a message originating from the bridged gateway 26-1 for processing by the virtual gateway 18-1 (FIG. 4, block 3002). The BNG 16 determines that the virtual gateway 18-1 has not been initiated (FIG. 4, block 3004). The BNG 16 initiates the virtual gateway 18-1 (FIG. 4, block 3006). The BNG 16 provides the message to the virtual gateway 18-1 (FIG. 4, block 3008).

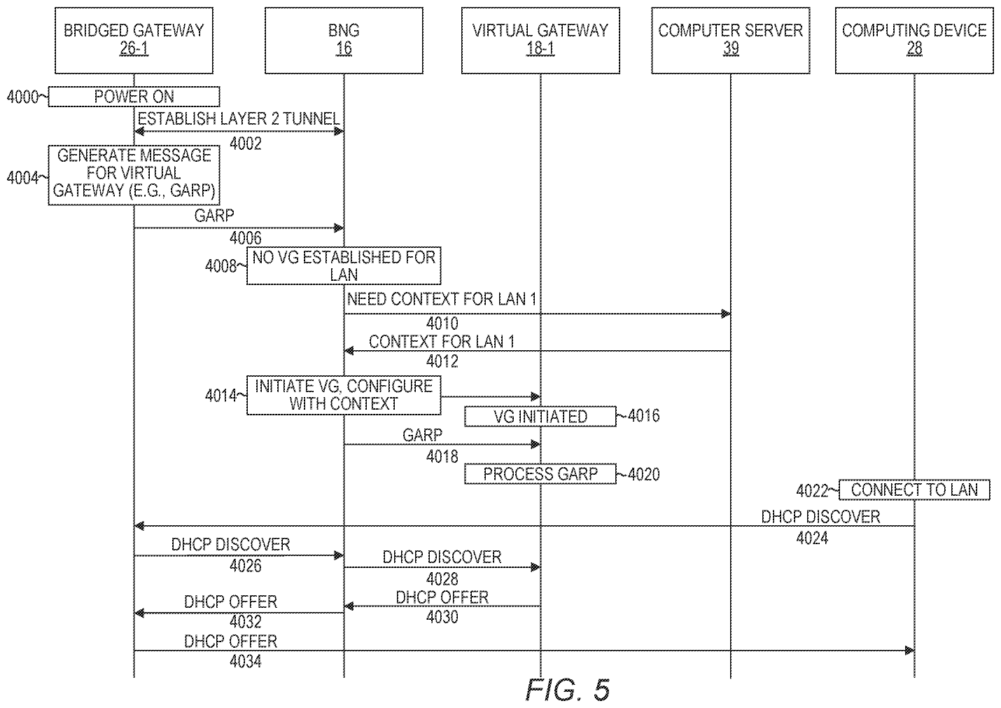

FIG. 5 is a sequence diagram illustrating messages communicated between and actions taken by certain components illustrated in FIG. 1 to implement preloading a customer context in a virtual gateway according to one implementation. The bridged gateway 26-1 is powered on (FIG. 5, block 4000). During the initialization phase, the bridged gateway 26-1 establishes a layer 2 tunnel with the BNG 16 which is on a different network than the bridged gateway 26-1 (FIG. 5, block 4002). The bridged gateway 26-1 then generates a message that will need to be processed by a virtual gateway, such as, by way of non-limiting example, a gratuitous ARP message (FIG. 5, block 4004). The bridged gateway 26-1 sends the message to the BNG 16 via the layer 2 tunnel (FIG. 5, block 4006).

The BNG 16 receives the message, and determines that no virtual gateway has yet been generated for the LAN associated with the bridged gateway 26-1 (FIG. 5, block 4008). The BNG 16 requests the context for the subscriber associated with the bridged gateway 26-1 from the computer server 39 (FIG. 5, block 4010). The computer server 39 replies with the appropriate context (FIG. 5, block 4012). The BNG 16 initiates the virtual gateway 18-1 and configures the virtual gateway 18-1 with the context (FIG. 5, blocks 4014-4016). The BNG 16 provides the message to the virtual gateway 18-1 (FIG. 5, block 4018). The virtual gateway 18-1 processes the message (FIG. 5, block 4020).

Subsequently, the computing device 28 connects to the LAN associated with the bridged gateway 26-1 (FIG. 5, block 4022). The computing device 28 broadcasts a DHCP Discover message (FIG. 5, block 4024). The bridged gateway 26-1 receives the DHCP Discover message and determines that, because it is a layer 2 broadcast message, the message should be processed by the virtual gateway 18-1. The bridged gateway 26-1 sends the DHCP Discover message toward the virtual gateway 18-1 via the layer 2 tunnel (FIG. 5, block 4026). The BNG 16 receives the DHCP Discover message and determines that the virtual gateway 18-1 has already been initiated and configured, and passes the DHCP Discover message to the virtual gateway 18-1 (FIG. 5, block 4028). The virtual gateway 18-1 processes the DHCP Discover message and sends a DHCP Offer message addressed to the MAC address of the computing device 28 via the layer 2 tunnel (FIG. 5, blocks 4030, 4032). The bridged gateway 26-1 receives the DHCP Offer message and transmits the DHCP Offer message to the computing device 28 using the MAC address of the computing device 28 as the destination address and the MAC address of the virtual gateway 18-1 as the source address (FIG. 5, block 4034).

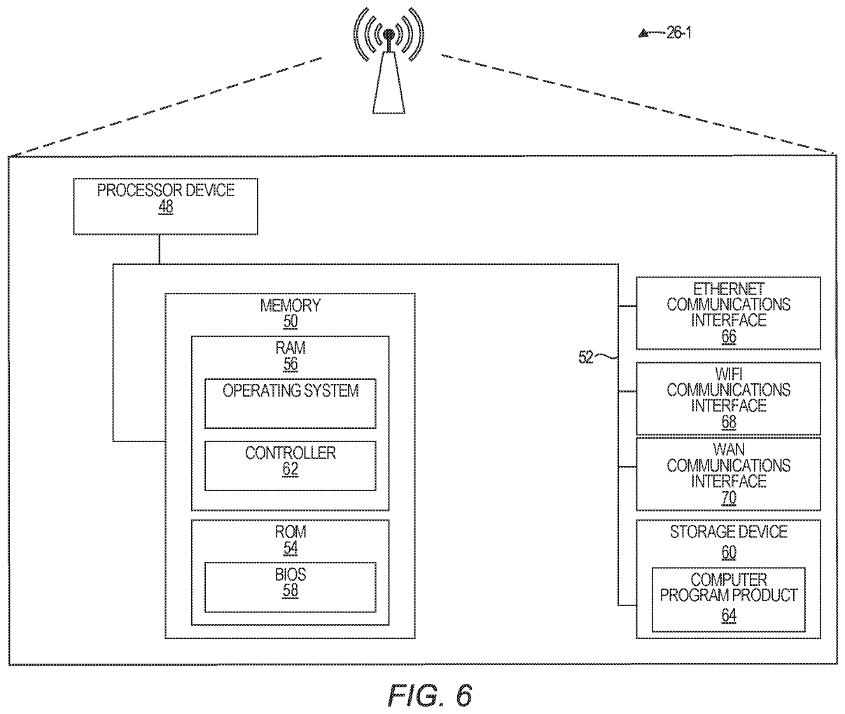

FIG. 6 is a block diagram of the bridged gateway 26-1 suitable for implementing examples disclosed herein. The bridged gateway 26-1 may comprise a learning bridge and Wi-Fi access point. The bridged gateway 26-1 includes a processor device 48, a system memory 50, and a system bus 52. The system bus 52 provides an interface for system components including, but not limited to, the system memory 50 and the processor device 48. The processor device 48 can be any commercially available or proprietary processor.

The system bus 52 may be any of several types of bus structures that may further interconnect to a memory bus (with or without a memory controller), a peripheral bus, and/or a local bus using any of a variety of commercially available bus architectures. The system memory 50 may include non-volatile memory 54 (e.g., read-only memory (ROM), erasable programmable read-only memory (EPROM), electrically erasable programmable read-only memory (EEPROM), etc.), and volatile memory 56 (e.g., random-access memory (RAM)). A basic input/output system (BIOS) 58 may be stored in the non-volatile memory 54 and can include the basic routines that help to transfer information between elements within the bridged gateway 26-1. The volatile memory 56 may also include a high-speed RAM, such as static RAM, for caching data.

The bridged gateway 26-1 may further include or be coupled to a non- transitory computer-readable storage medium such as a storage device 60, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 60 and other drives associated with computer-readable media and computer-usable media may provide non-volatile storage of data, data structures, computer-executable instructions, and the like.

A number of modules can be stored in the storage device 60 and in the volatile memory 56, including an operating system and one or more program modules, such as a controller 62, which may implement the functionality described herein in whole or in part. All or a portion of the examples may be implemented as a computer program product 64 stored on a transitory or non-transitory computer-usable or computer-readable storage medium, such as the storage device 60, which includes complex programming instructions, such as complex computer-readable program code, to cause the processor device 48 to carry out the steps described herein. Thus, the computer-readable program code can comprise software instructions for implementing the functionality of the examples described herein when executed on the processor device 48. The processor device 48, in conjunction with the controller 62 in the volatile memory 56, may serve as a controller, or control system, for the bridged gateway 26-1 that is to implement the functionality described herein.

The bridged gateway 26-1 may have a number of communication interfaces including, for example, one or more ethernet communication interfaces 66 to which a computing device, such as the computing device 28, can be connected via an appropriate cable. The bridged gateway 26-1 may also serve as a Wi-Fi access point and have a Wi-Fi communication interface 68 via which computing devices can connect to the bridged gateway 26-1 wirelessly. The bridged gateway 26-1 includes a WAN interface 70 via which the bridged gateway 26-1 can communicate with a device associated with the service provider network 12, such as a cable or fiber modem, or the like, and which facilitates communications with, for example, the BNG 16.

Individuals will recognize improvements and modifications to the preferred examples of the disclosure. All such improvements and modifications are considered within the scope of the concepts disclosed herein and the claims that follow.

What is claimed is:

1. A method comprising:
establishing, by a bridged gateway coupled to a local area network (LAN) in a premises, a layer 2 tunnel with a first computing device coupled to a different network, the first computing device operable to provide a virtual gateway that provides default gateway functionality to computing devices connected to the LAN;
generating, by the bridged gateway, a first message to be processed by the virtual gateway; and
sending, by the bridged gateway to the first computing device, the first message to cause the first computing device to initiate the virtual gateway.

2. The method of claim 1 wherein the layer 2 tunnel comprises a Generic Routing Encapsulation (GRE) tunnel.

3. The method of claim 1 wherein the first computing device comprises a broadband network gateway operable to initiate a plurality of virtual gateways, each virtual gateway of the plurality of virtual gateways operable to provide default gateway functionality to corresponding LANs of a plurality of LANs.

4. The method of claim 1 further comprising:
receiving, by the bridged gateway, a second message from a second computing device connected to the LAN;
determining, by the bridged gateway, that the second message is a message to be processed by the virtual gateway;
encapsulating the second message into a layer 3 protocol; and
sending the second message to the first computing device via the layer 2 tunnel.

5. The method of claim 4 further comprising:
receiving, by the bridged gateway via the layer 2 tunnel, a layer 3 packet that includes a layer 2 reply to the second message from the virtual gateway;
extracting, by the bridged gateway, the layer 2 reply; and
sending by the bridged gateway to the second computing device, the layer 2 reply, the layer 2 reply comprising a source MAC address of the virtual gateway.

6. The method of claim 1 further comprising:
subsequent to sending the first message to cause the first computing device to initiate the virtual gateway, generating, by the bridged gateway, a second message to be processed by the virtual gateway; and
sending, by the bridged gateway to the first computing device, the second message.

7. The method of claim 6 further comprising:
setting, by the bridged gateway, a timer;
determining that the timer has expired; and
in response to determining that the timer has expired, sending, by the bridged gateway to the first computing device, the second message.

8. The method of claim 1 wherein the default gateway functionality includes a DHCP service and a router function to facilitate communication between a computing device connected to the LAN and a computing device connected to another network.

9. The method of claim 1 wherein establishing the layer 2 tunnel and sending the first message to the first computing device is performed during an initialization stage of the bridged gateway and prior to receipt of any messages by the bridged gateway from any computing device connected to the LAN.

10. A computing device, comprising:
a memory;
a transceiver operable to be coupled to a local area network (LAN); and
a processor device coupled to the memory and the transceiver and being operable to:
establish a layer 2 tunnel with a remote computing device coupled to a different network, the remote computing device operable to provide a virtual gateway that provides default gateway functionality to computing devices connected to the LAN;
generate a first message to be processed by the virtual gateway; and
send, to the remote computing device, the first message to cause the remote computing device to initiate the virtual gateway.

11. The computing device of claim 10 wherein the layer 2 tunnel comprises a Generic Routing Encapsulation (GRE) tunnel.

12. The computing device of claim 10 wherein the remote computing device comprises a broadband network gateway operable to initiate a plurality of virtual gateways, each virtual gateway of the plurality of virtual gateways operable to provide default gateway functionality to corresponding LANs of a plurality of LANs.

13. The computing device of claim 10 wherein the processor device is further operable to:
receive a second message from a second computing device connected to the LAN;
determine that the second message is a message to be processed by the virtual gateway;
encapsulate the second message into a layer 3 protocol; and
send the second message to the first computing device via the layer 2 tunnel.

14. The computing device of claim 13 wherein the processor device is further to:
receive, via the layer 2 tunnel, a layer 3 packet that includes a layer 2 reply to the second message from the virtual gateway;
extract the layer 2 reply; and
send to the second computing device, the layer 2 reply, the layer 2 reply comprising a source MAC address of the virtual gateway.

15. The computing device of claim 10 wherein the processor device is further to:
subsequent to sending the first message to cause the first computing device to initiate the virtual gateway, generate a second message to be processed by the virtual gateway; and
send, to the first computing device, the second message.

16. The computing device of claim 10 wherein the processor device is further to:
set a timer;
determine that the timer has expired; and
in response to determining that the timer has expired, send, to the first computing device, a second message.

17. The computing device of claim 10 wherein the default gateway functionality includes a DHCP service functionality and a router functionality to facilitate communication between a computing device connected to the LAN and a computing device connected to another network.

18. The computing device of claim 10 wherein establishing the layer 2 tunnel and sending the first message to the first computing device is performed during an initialization stage of the computing device and prior to receipt of any messages by the computing device from any computing device connected to the LAN.

19. A method comprising:
establishing, by a computing device coupled to a network, a layer 2 tunnel with a bridged gateway coupled to a local area network (LAN) in a premises, the computing device being operable to provide a virtual gateway that provides default gateway functionality to computing devices connected to the LAN;
receiving, by the computing device from the bridged gateway via the layer 2 tunnel a message originating from the bridged gateway for processing by the virtual gateway;
determining, by the computing device, that the virtual gateway has not been initiated;
initiating, by the computing device, the virtual gateway; and
providing, by the computing device to the virtual gateway, the message.

20. The method of claim 19 wherein the message comprises a gratuitous address resolution protocol (ARP) reply message.
